(19) United States
(12) Patent Application Publication
(10) Pub. No.: US 2024/0059178 A1
(43) Pub. Date: Feb. 22, 2024

(54) ELECTRIC WORK VEHICLE

(71) Applicant: KUBOTA CORPORATION, Osaka (JP)

(72) Inventor: Shunya TAKASE, Osaka (JP)

(73) Assignee: KUBOTA CORPORATION, Osaka (JP)

(21) Appl. No.: 18/133,704

(22) Filed: Apr. 12, 2023

(30) Foreign Application Priority Data
Aug. 19, 2022 (JP) 2022-130929

(51) Int. Cl. B60L 58/12; B60L 58/24

(52) U.S. Cl. CPC B60L 58/12; B60L 58/24; B60L 2250/16; B60L 2250/10; B60L 2200/40

(57) ABSTRACT

An electric work vehicle, which is configured to be driven with use of motive power of an electric motor configured to be supplied with electric power from a rechargeable battery, comprises: a drive controller configured to control driving of the electric work vehicle and including a start determination module configured to determine whether or not to permit the electric motor to be started; a display unit configured to display vehicle state information regarding the electric work vehicle and including a start permission indicator configured to indicate that the electric motor is permitted to be started; and a notification controller configured to control display in the display unit.

### CROSS REFERENCE TO RELATED APPLICATIONS

This application claims the benefit of priority to Japanese Patent Application No. 2022-130929 filed on Aug. 19, 2022. The entire contents of this application are hereby incorporated herein by reference.

### BACKGROUND OF THE INVENTION

### Field of the Invention

The present invention relates to an electric work vehicle driven by motive power from an electric motor that is supplied with electric power from a rechargeable battery.

### Description of the Related Art

For electric work vehicles, which are traveling vehicles that use batteries and electric motors as motive power sources, battery information regarding the state of the battery and electric motor information regarding the state of the electric motor is important. Accordingly, a manager (which may alternatively be an operator) of the electric work vehicle needs to be notified of this battery information and electric motor information. In an electric work vehicle described in JP 2021-080703A, a display device displays a remaining battery capacity. In a rechargeable electric vehicle described in JP 2021-123882A, a display module of a display device displays operational information. The operational information includes cumulative working time of the vehicle, the temperature of a driving battery, which is information regarding a driving battery, the remaining battery capacity, and estimated operable time. If the electric vehicle is in a normal charging mode or a rapid charging mode, the remaining battery capacity, elapsed time and/or remaining time regarding the charging, information indicating that normal charging or rapid charging is in progress, and information indicating the progress of the charging are displayed. The voltage, temperature, current, or the like of the driving battery can also be displayed by the operator operating an operation unit of the display device. Further, this rechargeable electric vehicle determines inoperability of the electric motor caused by, for example, a malfunction of the driving battery or a high-voltage circuit, and also includes an indicator light that indicates the determination results. There are times where it is not appropriate to start the electric motor of an electric work vehicle, considering safety or other factors, even when the electric motor is operable. For this reason, it is convenient to determine not only whether or not the electric motor is simply operable, but also whether or not the current state of the electric work vehicle is appropriate for starting the electric motor, i.e., whether or not the timing for starting the electric motor is appropriate. However, conventional electric work vehicles, such as the vehicles disclosed in JP 2021-080703A and JP 2021-123882A do not take into account the technical idea of displaying the results of determining whether or not the timing for starting the electric motor is appropriate. This is a disadvantage in that, for example, an operator who is not accustomed to the electric work vehicle may start the electric motor even in a situation where the electric motor should not be started.

### SUMMARY OF THE INVENTION

An electric work vehicle according to the present invention is an electric work vehicle configured to be driven with use of motive power of an electric motor configured to be supplied with electric power from a rechargeable battery, the electric work vehicle comprising:
a drive controller configured to control driving of the electric work vehicle and including a start determination module configured to determine whether or not to permit the electric motor to be started;
a display unit configured to display vehicle state information regarding the electric work vehicle and including a start permission indicator configured to indicate that the electric motor is permitted to be started; and
a notification controller configured to control display in the display unit,
wherein the notification controller generates a display control signal for the start permission indicator based on a result of the determination by the start determination module.

According to this configuration, the start determination module of the drive controller, which controls driving of the electric work vehicle, determines whether or not to permit the electric motor is to be started. If the determination result is that the electric motor is permitted to be started, the start permission indicator of the display unit indicates that the electric motor is permitted to be started. That is, the operator is notified of information regarding whether or not to permit the electric motor is to be started via the start permission indicator. The operator starts the electric motor if the start permission indicator indicates that the electric motor is permitted to be started, and does not start the electric motor if the start permission indicator does not indicate that the electric motor is permitted to be started. This enables the operator to start the electric motor at an appropriate timing.

In one preferred embodiment of the electric work vehicle of the present invention,
the start determination module determines whether or not to prohibit the electric motor from being started, while the battery is being charged.

A particularly inappropriate timing for starting the electric motor is during charging of a battery.

In one preferred embodiment of the electric work vehicle of the present invention,
the display unit includes a charging indicator configured to indicate a charging state of the battery, and
the charging indicator indicates normal charging while the battery is being normally charged, and indicates that the charging has abnormally ended in response to charging ending abnormally.

The display unit of this configuration includes the charging indicator that indicates the charging state of the battery, in addition to the start permission indicator. This enables the operator to understand not only the timing for starting the electric motor but also the charging state, which affects the operation of the electric motor.

In one preferred embodiment of the electric work vehicle of the present invention, the display unit includes:
an electric drive warning indicator configured to indicate an error in an electric drive system; and
a vehicle state warning indicator configured to indicate a vehicle state error.

This configuration enables the operator to understand, through the display unit, that a problem has occurred in an electric drive system including the electric motor of the electric work vehicle, and that a problem has occurred in the vehicle state of the electric work vehicle.

In one preferred embodiment of the electric work vehicle of the present invention,
the display unit includes:
   a remaining battery capacity indicator configured to indicate a remaining battery capacity of the battery; and
   a battery temperature indicator configured to indicate a temperature of the battery.

The remaining battery capacity and the battery temperature, which the operator should first pay attention to for battery management, being exhibited together with other information using the display unit is advantageous in understanding the comprehensive state of the electric work vehicle.

In one preferred embodiment of the electric work vehicle of the present invention, the drive controller includes an output limiter configured to limit output of the electric motor based on a state of an electric drive system, and
the display unit includes an output limitation indicator configured to indicate an output limitation while the electric motor is subjected to the output limitation.

The electric motor may be permitted to be operated at a low output, even if it is not appropriate to operate the electric motor, depending on the state of the electric drive system that is defined by the traveling state, working state, charging state, or the like. Further, the operation of the electric motor needs to be continued for emergency evacuation or the like, even if the output thereof is limited to a low level. It is favorable that the operator understands the operation of the electric motor under this type of low-output limitation.

In one preferred embodiment of the electric work vehicle of the present invention,
the notification controller notifies an operator of information that is to be given to the operator, with use of audio via an audio notification device.

Displaying various types of information on the display unit provides the aforementioned advantages, but the driver needs to look forward. Moreover, the display becomes difficult to see if sunlight shines on the display unit. In the configuration to address this type of issue, particularly in case of a malfunction, an audio warning is given to notify the user of the malfunction. This enables visual and audio information to be visually and audibly given to the operator, thus preventing notification information for the operator from being lost.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view of a tractor.

FIG. 2 is a left side view showing the placement of a motor and a traveling battery.

FIG. 3 is a schematic diagram showing a flow of motive power transfer.

FIG. 4 is a front view of a steering wheel and a front panel.

FIG. 5 is a front view of a meter panel.

FIG. 6 is a functional block diagram showing functional modules of a battery system.

### DETAILED DESCRIPTION OF THE PREFERRED EMBODIMENTS

Modes for carrying out the present invention will be described with reference to the drawings. An “F” arrow”, a “B” arrow, an “L” arrow, and an “R” arrow in the diagrams respectively indicate forward, backward, leftward, and rightward directions in the following description, unless otherwise stated. A “U” arrow and a “D” arrow in the diagrams indicate upward and downward directions, respectively.

### Overall Configuration of Tractor

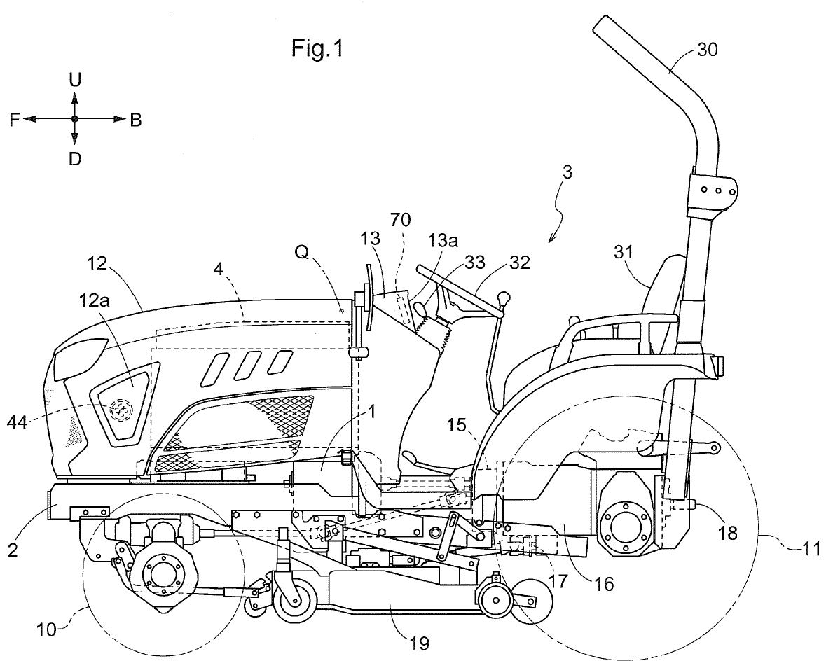

A tractor serving as an example of an electric work vehicle according to the present invention will be described below. The tractor includes left and right front wheels 10, left and right rear wheels 11, and a cover member 12, as shown in FIG. 1.

The tractor also includes a body frame 2 and an operator section 3. The left and right front wheels 10 and the left and right rear wheels 11 support the body frame 2. The cover member 12 is in a front part of the body. The operator section 3 is rearward of the cover member 12.

The operator section 3 has a protective frame 30, an operator seat 31, and a steering wheel 32. The steering wheel 32 can be operated by an operator, who is in the operator section 3 and sitting on the operator seat 31. The left and right front wheels 10 are steered by operating the steering wheel 32. A front panel 13 is forward of the operator seat 31, and a portion of the front panel 13 is a meter panel 13a. The operator can perform various operations in the operator section 3.

The tractor also includes a battery 4, which is a traveling battery. The cover member 12 is able to pivot about an opening-closing axis Q, which is parallel to the left-right direction of the body of the tractor, in such a manner as to open and close. The cover member 12 covers the battery 4 while the cover member 12 is closed. A charging cover 12a is provided in a left side face of a front part of the cover member 12, and is able to pivot in such a manner as to open and close. A charging power connector 44, into which a power supply cable is inserted during charging, is exposed by opening the charging cover 12a.

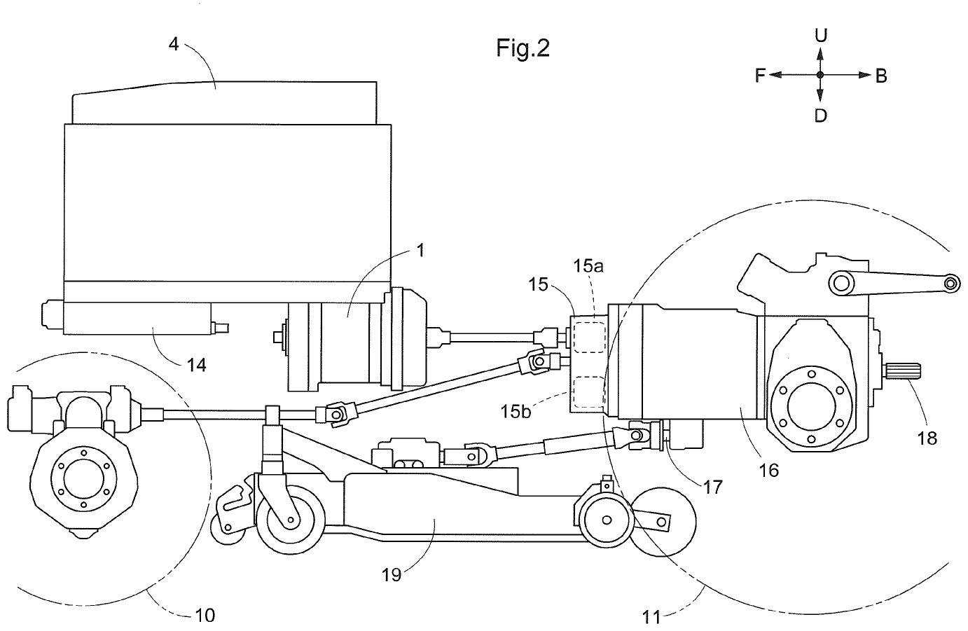

The tractor also includes an inverter 14 and an electric motor 1, as shown in FIG. 2. The battery 4 supplies electric power to the inverter 14. The inverter 14 converts direct-current electric power from the battery 4 to alternating-current electric power, and generates driving electric power to be supplied to the electric motor 1. The driving electric power is alternating-current electric power generated by the inverter 14.

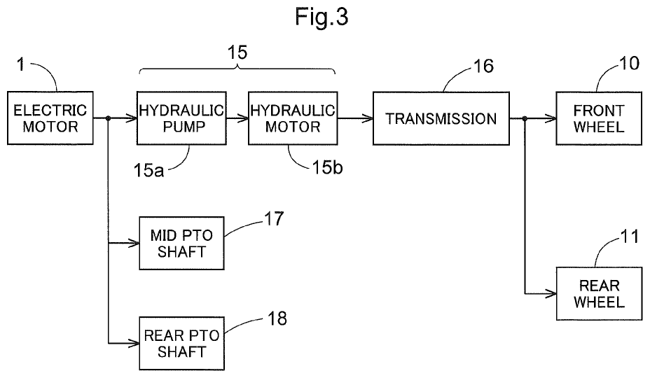

The tractor includes a hydrostatic continuously variable transmission and a transmission 16, as shown in FIGS. 2 and 3. The hydrostatic continuously variable transmission 15 has a hydraulic pump 15a and a hydraulic motor 15b, as shown in FIG. 3.

Rotational power from the electric motor 1 drives the hydraulic pump 15a. Rotational power is output from the hydraulic motor 15b in response to driving of the hydraulic pump 15a. The hydrostatic continuously variable transmission 15 is configured in such a manner that the speed of rotational power is steplessly changed between the hydraulic pump 15a and the hydraulic motor 15b.

Rotational power output from the hydraulic motor 15b is transferred to the transmission 16. Rotational power transferred to the transmission 16 is subjected to speed change by a gear-type speed change mechanism of the transmission 16, and is distributed to the left and right front wheels 10 and the left and right rear wheels 11. This drives the left and right front wheels and the left and right rear wheels 11.

The tractor also includes a mid PTO shaft 17 and a rear PTO shaft 18, as shown in FIG. 3. Rotational power output from the electric motor 1 is distributed to the hydraulic pump 15a, the mid PTO shaft 17, and the rear PTO shaft 18. This rotates the mid PTO shaft 17 and the rear PTO shaft 18.

Rotational power of the mid PTO shaft 17 or the rear PTO shaft 18 drives a work device if the work device is connected to the mid PTO shaft 17 or the rear PTO shaft 18. For example, a mowing device 19 is connected to the mid PTO shaft 17 in this embodiment, as shown in FIG. 2. Rotational power of the mid PTO shaft 17 drives the mowing device 19.

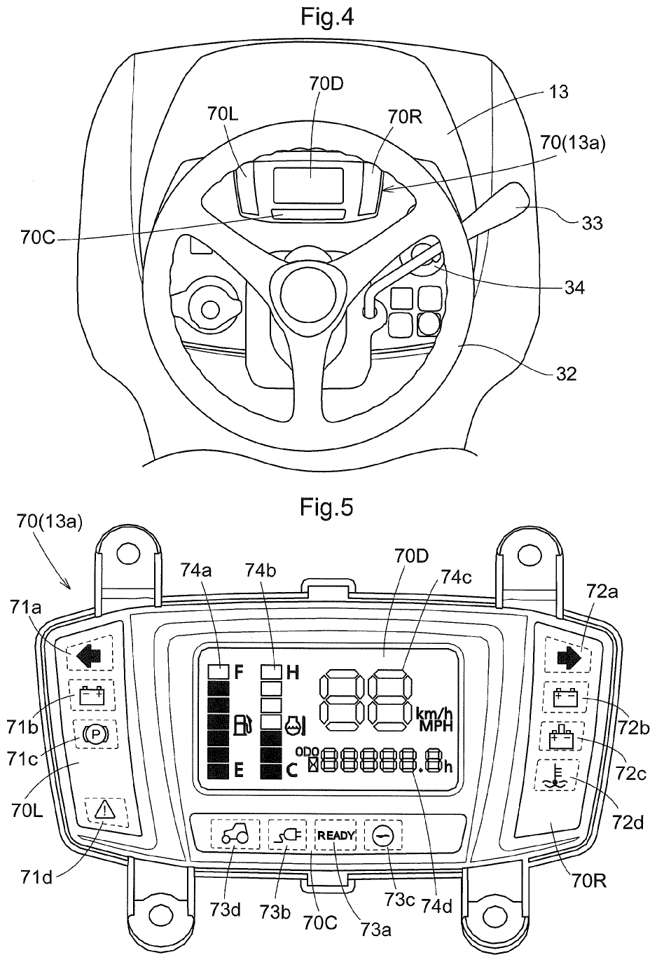

FIG. 4 shows the steering wheel 32 and the front panel 13, and FIG. 5 shows the meter panel 13a built in the front panel 13. The meter panel 13a is configured as a display unit 70 for notifying the operator of various types of information. The display unit 70 includes a left LED display 70L, a right LED display 70R, a central LED display 70C, and a liquid-crystal display 70D. The left LED display 70L, the right LED display 70R, and the central LED display 70C surround the liquid-crystal display 70D from below.

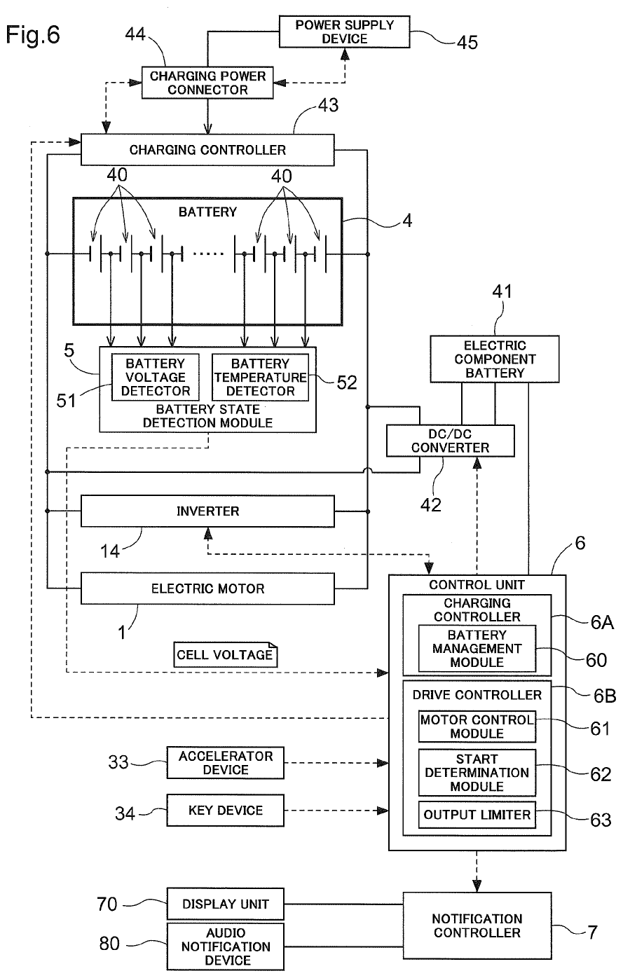

The left LED display 70L includes, for example, a left-direction indicator LED 71a, an electric component battery LED 71b, a parking brake LED 71c, and a master warning LED 71d. The left-direction indicator LED 71a is an indicator for indicating a turn to the left. The electric component battery LED 71b is an indicator for indicating the state of an electric component battery 41 (see FIG. 6). The parking brake LED 71c is an indicator for indicating the on- or off-state of the parking brake. The master warning LED 71d is a vehicle state warning indicator that lights up based on vehicle state information, which is generated in response to detection of a vehicle state error indicating a malfunction in a battery control system, an electric drive system, and/or a mechanical control system.

The right LED display 70R includes, for example, a right-direction indicator LED 72a, a battery LED 72b, a battery temperature LED 72c, and a cooling water temperature LED 72d. The right LED display 70R is an indicator for indicating a turn to the right. The battery LED 72b is an indicator that warns of a state, specifically a low-voltage state, of the battery 4 serving as an electric power source for the electric motor 1. The battery temperature LED 72c is an indicator that warns of high temperature of the battery 4. The cooling water temperature LED 72d is an indicator that warns of high temperature of cooling water for cooling the inverter 14 and the like.

The central LED display 70C includes, for example, a start permission LED 73a, a charging state LED 73b, an output limitation LED 73c, and an electric system LED 73d. The start permission LED 73a is used as a start permission indicator that lights up while the electric motor 1 is permitted to be started, and displays the word “READY”. The start permission LED 73a is off while the battery 4 is being charged, since the tractor is prohibited from travelling during charging. The charging state LED 73b, which has a plug shape, is used as a charging indicator for indicating the charging state of the battery 4. The charging state LED 73b lights up in response to the power supply cable being inserted into the charging power connector 44 and charging control processing starting. The charging state LED 73b remains normally lit during normal charging, and rapidly flashes to indicate that charging has abnormally ended in case of abnormal ending of charging. The output limitation LED 73c is used as an output limitation indicator that lights up in response to the output of the electric motor 1 being limited due to the state of the battery 4 and/or the inverter 14. The electric system LED 73d is used as an electric drive warning indicator, and lights up in response to a malfunction occurring in the electric drive system including the electric motor 1.

The liquid-crystal display 70D includes, for example, a remaining battery capacity display region 74a, a battery temperature display region 74b, a rotational speed display region 74c, and a multipurpose display region 74d. The remaining battery capacity display region 74a has the form of a segmented bar graph, and is used as a remaining battery capacity indicator for indicating the remaining capacity of the battery 4 in increments. The battery temperature display region 74b also has the form of a segmented bar graph, and is used as a battery temperature indicator for indicating the battery temperature of the battery 4 in increments. The rotational speed display region 74c and the multipurpose display region 74d are 7-segment displays that are commonly used to display digital numbers. The multipurpose display region 74d is usually used as an hour meter and a meter for indicating battery power consumption per travel unit, and displays an error code in case of an error.

The display unit 70 is subjected to display control in accordance with a display control signal from a notification controller 7, as shown in FIG. 6. The notification controller 7 is connected to the control unit 6 and generates a display control signal based on a notification command from the control unit 6. The notification controller 7 controls the display unit 70 built into the meter panel 13a and an audio notification device 80 for outputting audio warnings, such as a warning sound and an artificial voice, and gives visible or audible notifications regarding the traveling state, working state, battery state (battery charge and temperature), and whether or not the electric motor can be started, for example.

### Configuration of Motor and Battery Control System

FIG. 6 schematically shows a configuration for the control of the battery 4 and the electric motor 1. The motor and battery control system includes an accelerator device 33, a key device 34, a control unit 6, and the inverter 14. The control unit 6 controls the operation of the electric motor 1. The accelerator device 33 is located in the operator section 3. Although the structure of the accelerator device 33 is not shown in FIG. 6, the accelerator device 33 includes a pivotable lever and a potentiometer that is operated by pivoting the lever. The accelerator device 33 is connected to the control unit 6. The key device 34 is also connected to the control unit 6. The key device 34 is in the front panel 13 and turns the control unit 6 on and off (powers on and off).

The control unit 6 is also connected to the inverter 14, and gives a drive command to the inverter 14 in accordance with a command from the accelerator device 33. The inverter 14 adjust electric power supplied from the battery 4 to the electric motor 1 and controls the output of the electric motor 1 in accordance with the command from the control unit 6.

The charging controller 43 charges the battery 4 with use of a power supply device 45 connected to the charging power connector 44. The charging power connector 44 has a power supply socket, which is connected to a power supply connector of a charging cable extending from the power supply device during charging.

The battery 4 is a lithium-ion battery, which includes a large number of stacked battery cells 40, which are small, low-voltage unit batteries. A battery state detection module 5 for detecting the battery state includes a battery voltage detector 51 and a battery temperature detector 52. The battery voltage detector 51 is capable of detecting, as a cell voltage, a voltage across nodes between a plurality of battery cells 40 that are connected in series. Detection signals of the battery voltage detector 51 and the battery temperature detector 52 are transmitted to the control unit 6. Note that the battery 4 may alternatively be a solid-state battery, for example.

The tractor includes an electric component battery 41 for supplying electric power to the control unit 6 and other electric components, in addition to the battery 4. The electric component battery 41 supplies low-volt (12-volt) electric power to activate the electric components. The electric component battery 41 is charged with use of electric power supplied from the battery 4 via a DC/DC converter 42. The DC/DC converter 42 is subjected to control by the control unit 6. The control unit 6 also manages the charging state of the electric component battery 41.

The control unit 6 includes a charging controller 6A and a drive controller 6B as functional elements that are particularly related to the present invention. The charging controller 6A controls charging and discharging of the battery 4. The drive controller 6B controls driving of the tractor.

The charging controller 6A has a battery management module 60. The battery management module 60 enters a charging mode upon detecting that the power supply connector of the charging cable from the power supply device 45 has been inserted into the power supply socket of the charging power connector 44. A charging program of the charging controller 43 is executed to charge the battery 4 in response to the battery management module 60 transmitting a charging start command to the charging controller 43. After the charging has appropriately ended, the control unit 6 is deactivated, and the power source is shut off. If an error occurs during this charging processing, the battery management module 60 generates error information and transmits it to the notification controller 7.

The drive controller 6B has a motor control module 61, a start determination module 62, and an output limiter 63. The motor control module 61 controls driving of the electric motor 1. Specifically, the motor control module 61 generates a drive signal for driving the electric motor 1 based on a signal from the accelerator device 33, and gives the inverter 14 the generated drive signal. The start determination module 62 determines whether or not to permit the electric motor 1 to be started, in accordance with start permission determination rules. For example, the start permission determination rules include: (i) the electric motor 1 is prohibited from being started while the battery 4 is being charged; (ii) the electric motor 1 is permitted to be started if there no issue with the electric drive control system at a point in time when the key device 34 turns the control unit 6 on; (iii) the electric motor 1 is prohibited from being started if the battery state exceeds a limit value, as in the case of a drop in the battery voltage or an increase in the battery temperature. The results of the determination by the start determination module 62 are transmitted to the notification controller 7 and used to control the display of the start permission LED 73a, which is a start permission indicator in the display unit 70.

If the battery state deteriorates, as in the case of a drop in the battery voltage or an increase in the battery temperature, the output limiter 63 gives the motor control module 61 an output limitation command indicating that the output of the electric motor 1 be limited to a preset output limit. If the output of the electric motor 1 is limited, the notification controller 7 turns on the output limitation LED 73c, which is an output limitation indicator in the display unit 70.

### Other Embodiments

(1) Whether or not the electric motor 1 is prohibited from being started during charging may be determined at a point in time when the charging cable from the power supply device 45 is connected to the charging power connector 44, or at a point in time when charging processing is actually executed.
(2) The form of each indicator in the display unit 70 is not limited to that shown in FIG. 5. As for the placement of the indicators, some of the indicators may alternatively be in an area other than the front panel 13. Some or all of the notification controller 7, the display unit 70, and the audio notification device 80 may be a general-purpose terminal, such as a tablet computer.
(3) Each functional block in the functional block diagram in FIG. 5 may be divided into a plurality of sub-blocks, or two or more functional blocks may be integrated.

Note that the configuration disclosed in the above embodiments (including other embodiments; the same applies to the following) may be combined with configurations disclosed in other embodiments, as long as no contradiction arises. The embodiments disclosed herein are illustrative. Embodiments of the present invention are not limited thereto, and can be altered without departing from the object of the present invention.

The present invention is applicable to not only tractors but also various electric work vehicles such as rice transplanters, combines, and construction machines.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric work vehicle configured to be driven with use of motive power of an electric motor configured to be supplied with electric power from a rechargeable battery, the electric work vehicle comprising:
a drive controller configured to control driving of the electric work vehicle and including a start determination module configured to determine whether or not to permit the electric motor to be started;
a display unit configured to display vehicle state information regarding the electric work vehicle and including a start permission indicator configured to indicate that the electric motor is permitted to be started; and
a notification controller configured to control display in the display unit,
wherein the notification controller generates a display control signal for the start permission indicator based on a result of the determination by the start determination module.

2. The electric work vehicle according to claim 1, wherein
the start determination module determines whether or not to prohibit the electric motor from being started, while the battery is being charged.

3. The electric work vehicle according to claim 1, wherein
the display unit includes a charging indicator configured to indicate a charging state of the battery, and
the charging indicator indicates normal charging while the battery is being normally charged, and indicates that the charging has abnormally ended in response to charging ending abnormally.

4. The electric work vehicle according to claim 1, wherein
the display unit includes:
an electric drive warning indicator configured to indicate an error in an electric drive system; and
a vehicle state warning indicator configured to indicate a vehicle state error.

5. The electric work vehicle according to claim 1, wherein
the display unit includes:
a remaining battery capacity indicator configured to indicate a remaining battery capacity of the battery; and
a battery temperature indicator configured to indicate a temperature of the battery.

6. The electric work vehicle according to claim 1, wherein
the drive controller includes an output limiter configured to limit output of the electric motor based on a state of an electric drive system, and
the display unit includes an output limitation indicator configured to indicate an output limitation while the electric motor is subjected to the output limitation.

7. The electric work vehicle according to claim 1, wherein
the notification controller notifies an operator of information that is to be given to the operator, with use of audio via an audio notification device.
